(19) United States
(12) Patent Application Publication
(10) Pub. No.: US 2018/0063274 A1
(43) Pub. Date: Mar. 1, 2018

(54) DISTRIBUTED DATA STORAGE-FETCHING SYSTEM AND METHOD

(71) Applicant: HON HAI PRECISION INDUSTRY CO., LTD., New Taipei (TW)

(72) Inventor: CHENG-WEI LUO, New Taipei (TW)

(21) Appl. No.: 15/276,705

(22) Filed: Sep. 26, 2016

(30) Foreign Application Priority Data
Aug. 29, 2016 (CN) 201610745192.8

(51) Int. Cl. H04L 29/08; G06F 3/06

(52) U.S. Cl. CPC H04L 67/2847; G06F 3/0604; H04L 67/1097; G06F 3/0644; G06F 3/067; G06F 3/0631

(57) ABSTRACT

A distributed data storage-fetching system for storing and fetching data in multiple servers includes a partition module, a setup module, a first establishing module, and a second establishing module. The partition module segments a solid state disk of a first server to multiple partition areas. The SSD partitions are configured by the setup module, one for its own first server, and one for each of the other servers, accessible and sharable via a network. The first establishing module establishes the partitions in all SSDs into a block device. The second establishing module maps the block device to hard disk drives to establish a device mapper for storing and fetching data. A distributed data storage-fetching method is also provided.

### FIELD

The subject matter herein generally relates to data storage.

### BACKGROUND

In the field of data storage, mass-storage servers have evolved from a single mass-storage server to a distributed system composed of numerous, discrete, storage servers networked together. Each of the storage servers includes a solid state disk (SSD). However, it fails to balance the SSD storage space of the storage servers.

### BRIEF DESCRIPTION OF THE DRAWINGS

Implementations of the present technology will now be described, by way of example only, with reference to the attached figures.

FIG. 1 is a block diagram of an embodiment of a distributed data storage-fetching system of the present disclosure.

FIG. 2 is a block diagram of an another embodiment of a distributed data storage-fetching system of the present disclosure.

FIG. 3 is a diagram of an embodiment of an environment of a distributed data storage-fetching system of the present disclosure

FIG. 4 is a flow diagram of an embodiment of a distributed data storage-fetching method of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like.

The disclosure is described in relation to a distributed data storage-fetching system.

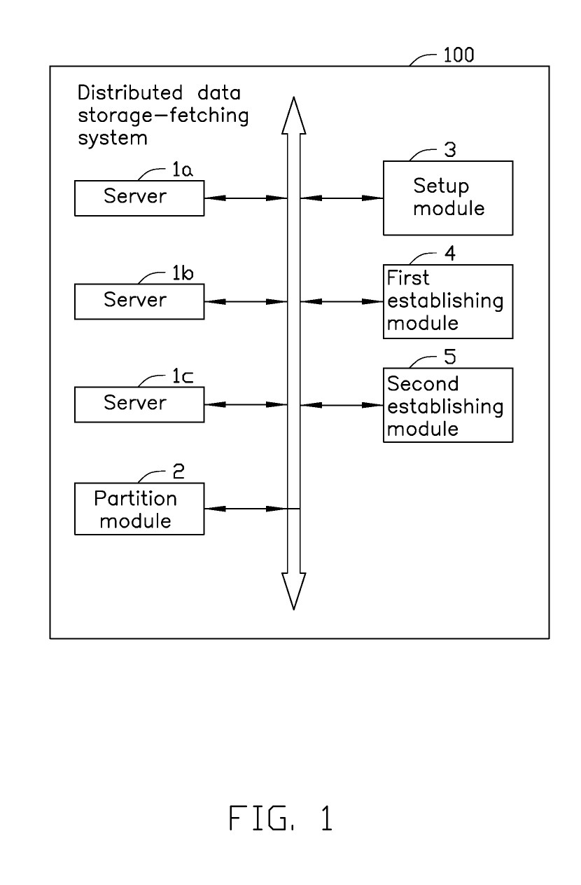

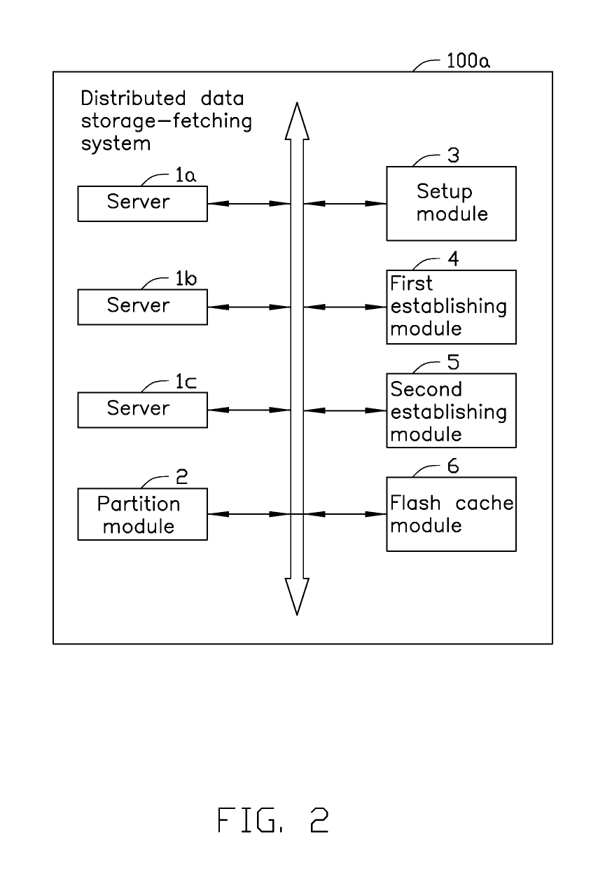

Referring to FIG. 1-FIG. 3, the distributed data storage-fetching system 100 comprises multiple servers, 1a to 1c. Each of the servers, 1a to 1c, comprises at least one solid state disk (SSD), at least one hard disk drive (HDD) and a server processor. The distributed data storage-fetching system 100 couples the HDDs of the servers, 1a to 1c, in series to form a large storage system.

In one embodiment, a number of the multiple servers, 1a to 1c, is three, and each of the servers, 1a to 1c comprises four HDDs.

The distributed data storage-fetching system 100 further comprises a partition module 2, a setup module 3, a first establishing module 4, and a second establishing module 5.

In one embodiment, the one or more function modules can include computerized code in the form of one or more programs that are stored in a memory, and executed by a processor.

The following will use the server 1a as an embodiment to describe a principle of the distributed data storage-fetching system 100.

The partition module 2 is configured to segment the SSD of the server 1a to multiple partition areas. A number of the multiple partition areas is equal to a number of the multiple servers 1a to 1c. It is means that the partition module 2 segments the SSD of the server 1a into three partition areas. The three partition areas can comprise a first partition area, a second partition area, and a third partition area.

The setup module 3 is configured to set the first partition area as a local partition area, that is, for the first server 1a. The setup module 3 further sets the second partition area and the third partition area respectively as remote partition areas to the servers, 1b to 1c. For example, the setup module 3 sets the second partition area as a remote partition area to the server 1b and sets the third partition area as a remote partition area to the server 1c. The second partition area and the third partition area are accessible to the servers, 1b to 1c, via the network.

In one embodiment, the setup module 3 sets the second and third partition areas via an internet small computer system interface (iSCSI) protocol.

The first establishing module 4 is configured to establish the local partition area of the first server 1a and two remote partition areas respectively shared by the servers, 1b to 1c, into a block device.

In one embodiment, the server 1b shares a remote partition area to the server 1a and shares a remote partition area to the server 1c. The server 1c shares a remote partition area to the server 1a and shares a remote partition area to the server 1b.

The second establishing module 5 is configured to establish the four HDDs of the server 1a into a redundant array of independent disks (RAID), and maps the block device to the RAID to establish a device mapper (DM), to store and fetch data.

In the distributed data storage-fetching system 100, the DM is used to replace the four HDDs as a base storage space. A speed of the SSD is greater than a speed of the HDD, and the RAID is mapped to the SSD. Data storing and fetching on the DM is faster than on the four HDDs.

In one embodiment, a store-and-fetch speed of the local partition area of the SSD is greater than that of the remote partition area of the SSD. The first establishing module 4 establishes the local partition area of the first server 1a and the two remote partition area respectively shared by the servers, 1b to 1c, into the block device according to a zettabyte file system (ZFS) algorithm. Then the block device sets the local partition area of the first server 1a as a first priority channel, and sets the two remote partition areas shared by the servers, 1b to 1c, as second priority channels. External data is preferentially written in the local partition area. When the local partition area is full, external data can be written in the two remote partition areas.

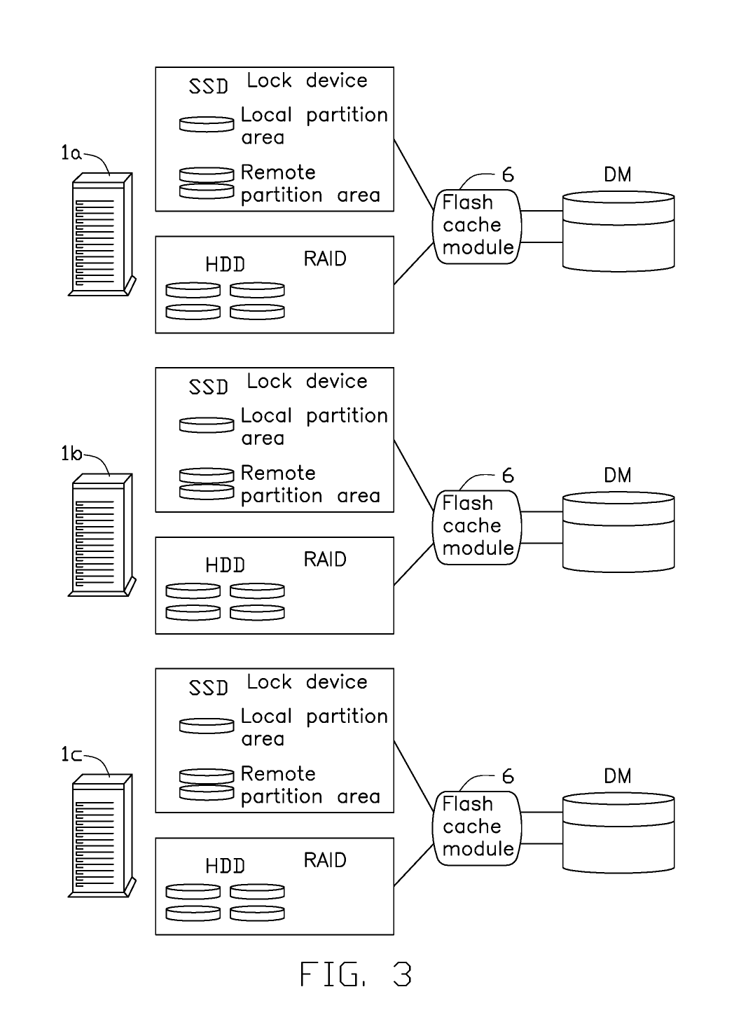

Referring to FIG. 3, a distributed data storage-fetching system 100a further comprises a flash cache module 6 as an addition to the distributed data storage-fetching system 100. The second establishing module 5 is configured to map the block device to the RAID to establish the DM via the flash cache module 6. The flash cache module 6 can comprise a flash cache algorithm or a buffer cache algorithm.

Detailed descriptions and configurations of the server 1b and the server 1c are omitted, these being substantially the same as for those of the server 1a.

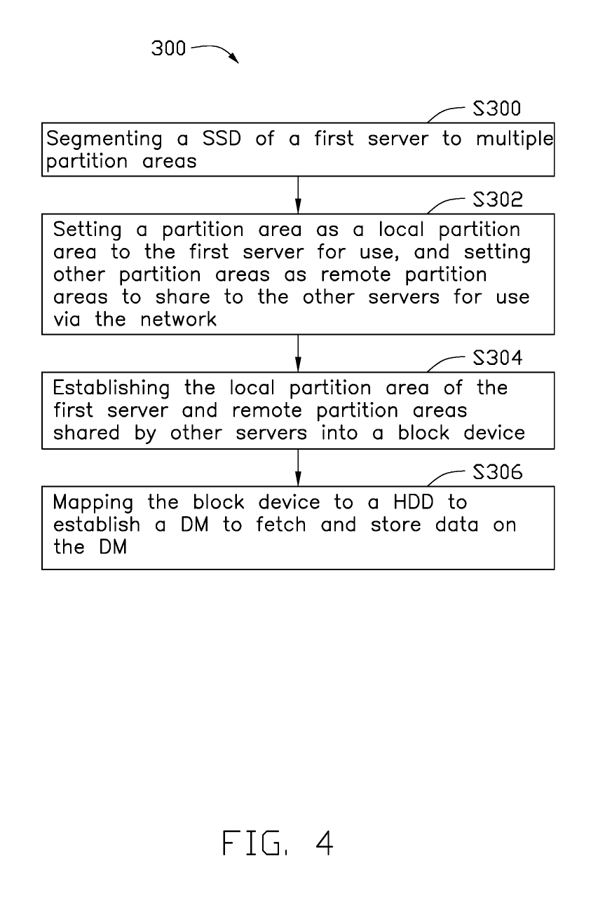

FIG. 4 illustrates an embodiment of a distributed data storage-fetching method 300. The flowchart presents an example embodiment of the method. The example method is provided by way of example, as there are a variety of ways to carry out the method. The method described below can be carried out using the configurations illustrated in FIG. 1-FIG. 3, for example, and various elements of these figures are referenced in explaining the example method. Each step shown in FIG. 4 represents one or more processes, methods, or subroutines, carried out in the example method. Furthermore, the illustrated order of steps is illustrative only and the order of the steps can change. Additional steps can be added or fewer steps may be utilized, without departing from this disclosure. The example method can begin at step S300.

In step S300, the partition module 2 segments the SSD of the server 1a into multiple partition areas. The number of the multiple partition areas is equal to the number of the multiple servers 1a to 1c. The multiple partition areas can comprise a first partition area, a second partition area, and a third partition area.

In step S302, the setup module 3 sets the first partition area as the local partition area for the first server 1a. The second and third partition areas are respectively set as the remote partition areas for the servers, 1b and 1c. The second partition area and the third partition area are accessible to the servers, 1b and 1c, via the network.

In step S304, the first establishing module 4 establishes the local partition area of the first server 1a and the two remote partition areas respectively shared by the servers, 1b to 1c, into a block device.

In step S306, the second establishing module 5 maps the block device to the HDD of the server 1a to establish a device mapper (DM), for storing and fetching data.

In one embodiment, in the step S302, the setup module 3 sets the second partition area and the third partition area as the remote partition areas to share to the servers, 1b to 1c, via iSCSI protocol.

In one embodiment, a store-and-fetch speed of the local partition area of the SSD is greater than that of a remote partition area of the SSD. In the step S304, the first establishing module 4 establishes the local partition area of the first server 1a and the two remote partition areas respectively shared by the servers, 1b to 1c, into the block device according to the ZFS algorithm. Then the block device sets the local partition area of the first server 1a as a first priority channel and sets the two remote partition areas shared by the servers, 1b to 1c, as second priority channels. External data is preferentially written in the local partition area. When the local partition area is full, external data can be written in the two remote partition areas.

In one embodiment, the server 1a comprises multiple HDDs. In the step S306, the second establishing module 5 establishes the multiple HDDs to the RAID, and maps the block device to the RAID to establish the DM via a flash cache module 6. The flash cache module 6 comprises a flash cache algorithm or a buffer cache algorithm.

The DM replaces the multiple HDDs as the base storage space. The speed of the SSD is greater than the speed of the multiple HDDs, and the RAID is mapped to the SSD. The store-and-fetch speed of external data on the DM is faster than that of external data on the multiple HDDs.

While the disclosure has been described by way of example and in terms of the embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A distributed data storage-fetching system comprising:
multiple servers, coupled to each other via a network, each servers comprising at least one solid state disk (SSD) and at least one hard disk drive (HDD);
a partition module, configured to segment a SSD of a first server into multiple partition areas;
a setup module, configured to set a partition area as a local partition area to the first server for use, and set other partition areas as remote partition areas to share to the other servers for use via the network;
a first establishing module, configured to establish the local partition area of the first server and remote partition areas shared by other servers into a block device; and
a second establishing module, configured to map the block device to a HDD to establish a device mapper (DM), to fetch and store data.

2. The distributed data storage-fetching system of claim 1, wherein a number of the multiple partition areas segmented by the partition module is equal to a number of the multiple servers.

3. The distributed data storage-fetching system of claim 1, wherein the first establishing module establishes the local partition area of the first server and the remote partition areas shared by other servers into the block device according to a zettabyte file system (ZFS) algorithm.

4. The distributed data storage-fetching system of claim 3, wherein the block device sets the local partition area of the first server as a first priority channel, and sets the remote partition areas shared by other servers as second priority channels.

5. The distributed data storage-fetching system of claim 1, wherein when the first server comprises multiple HDDs, the second establishing module is further configured to establish the multiple HDDs to a redundant array of independent disks (RAID), and map the block device to the RAID to establish the DM.

6. The distributed data storage-fetching system of claim 5, wherein the second establishing module is configured to map the block device to the RAID to establish the DM via a flash cache module; the flash cache module comprises a flash cache algorithm or a buffer cache algorithm.

7. The distributed data storage-fetching system of claim 1, wherein the setup module sets the other partition areas as the remote partition areas to share to the other servers for use via a internet small computer system interface (iSCSI) protocol.

8. A distributed data storage-fetching method used in a distributed data storage-fetching system, the distributed data storage-fetching system comprising multiple servers, the multiple servers coupled to each other via a network, the distributed data storage-fetching method comprising:
segmenting a SSD of a first server into multiple partition areas;
setting a partition area as a local partition area to the first server for use, and setting other partition areas as remote partition areas to share to the other servers for use via the network;
establishing the local partition area of the first server and remote partition areas shared by other servers into a block device; and
mapping the block device to a HDD to establish a DM to fetch and store data.

9. The distributed data storage-fetching method of claim 8, wherein a number of the multiple partition areas segmented by the partition module is equal to a number of the multiple servers.

10. The distributed data storage-fetching method of claim 8, wherein the step of establishing the local partition area of the first server and remote partition areas shared by other servers into a block device comprises:
establishing the local partition area of the first server and the remote partition areas shared by other servers into a block device according to a ZFS algorithm.

11. The distributed data storage-fetching method of claim 10, wherein the block device sets the local partition area of the first server as a first priority channel, and sets the remote partition areas shared by other servers as second priority channels.

12. The distributed data storage-fetching method of claim 11, wherein when the first server comprises multiple HDDs, the step of mapping the block device to a HDD to establish a DM to fetch and store data on the DM comprises:
establishing the multiple HDDs to a RAID, and mapping the block device to the RAID to establish a DM to fetch and store data on the DM.

13. The distributed data storage-fetching method of claim 12, wherein the step of mapping the block device to the RAID to establish a DM comprises:
mapping the block device to the RAID to establish a DM via a flash cache algorithm or a buffer cache algorithm.

14. The distributed data storage-fetching method of claim 8, wherein the step of setting other partition areas as remote partition areas to share to the other servers for use via the network comprises:
setting other partition areas as remote partition areas to share to the other servers for use via a iSCSI protocol.
